(19) United States
(12) Patent Application Publication
(10) Pub. No.: US 2007/0165493 A1
(43) Pub. Date: Jul. 19, 2007

(54) Method, apparatus and record carrier with average-runlength preserving code for improved readout parameter control

(75) Inventors: Coen Adrianus Verschuren, Eindhoven (NL); Willem Marie Julia Marcel Coene, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,918

(22) PCT Filed: Jan. 5, 2005
(86) PCT No.: PCT/IB05/50036

§ 371 Date: Jun. 29, 2006

(30) Foreign Application Priority Data
Jan. 14, 2004 (EP) 04100101.7

(51) Int. Cl. G11B 11/00

(52) U.S. Cl. 369/13.24

(57) ABSTRACT

The present invention relates to a method and apparatus for controlling at least one readout parameter of a magneto-optical domain expansion recording medium. An average detected runlength of the reading signal is monitored, and an error signal is generated on the basis of a comparison of the monitoring result with the predetermined average runlength that has been set during the encoding step. The at least one readout parameter is then controlled by means of the generated error signal. Furthermore, the present invention relates to a method, apparatus and record carrier wherein a runlength constraint is applied to at least one of the following quantities: mark regions and space regions in said storage layer, said runlength constraint being selected to keep an accumulated runlength deviation from a predetermined average runlength within a predetermined range. The proposed runlength property and control scheme provide the advantage that all detected runlengths contribute to the error signal to make the response must faster and to reduce readout errors.

The present invention relates to a method and apparatus for controlling at least one readout parameter, such as a radiation power and/or a field strength, during reading of a magneto-optical recording medium, such as a MAMMOS (Magnetic AMplifying Magneto-Optical System) disc, comprising a recording or storage layer and an expansion or readout layer. Furthermore, the present invention relates to a record carrier comprising a recording or storage layer and an expansion or readout layer, and to a method and apparatus for recording data on said record carrier.

In magneto-optical storage systems, the minimum width of the recorded marks is determined by the diffraction limit, i.e. by the Numerical Aperture (NA) of the focusing lens and the laser wavelength. A reduction of the width is generally based on shorter-wavelength lasers and higher-NA focusing optics. During magneto-optical recording, the minimum bit length can be reduced to below the optical diffraction limit by using Laser Pulsed Magnetic Field Modulation (LP-MFM). In LP-MFM, the bit transitions are determined by the switching of the field and the temperature gradient induced by the switching of the laser. Magnetic Super Resolution (MSR) or Domain Expansion (DomEx) methods have to be used for reading out the small crescent shaped marks recorded in this way. These technologies are based on recording media with several magnetostatic or exchange-coupled RE-TM layers. According to MSR, a readout layer on a magneto-optical disc is arranged to mask adjacent bits during reading, while, according to domain expansion, a domain in the center of a spot is expanded. The advantage of the domain expansion technique over MSR is that bits with a length below the diffraction limit can be detected with a signal-to-noise ratio (SNR) similar to that of bits with a size comparable to the diffraction-limited spot. MAMMOS is a domain expansion method based on magnetostatically coupled storage and readout layers, wherein a magnetic field modulation is used for expansion and collapse of expanded domains in the readout layer.

In the above-mentioned domain expansion techniques, like MAMMOS, a written mark from the storage layer is copied to the readout layer upon laser heating with the help of an external magnetic field. The low coercitivity of this readout layer will cause the copied mark to expand so as to fill the optical spot and can be detected with a saturated signal level which is independent of the mark size. Reversal of the external magnetic field collapses the expanded domain. A space in the storage layer, on the other hand, will not be copied and no expansion will occur.

The resolution of the MAMMOS readout process, that is, the smallest bit size that can be reproduced without interference from neighboring bits, is limited by the spatial extent (copy window) of the copy process, which is determined by the overlap of the temperature-induced coercitivity profile and the stray field profile of the bit pattern, which profile depends on the strength of the external magnetic field. The laser power that is used in the readout process should be high enough to enable copying. On the other hand, a higher laser power also increases the overlap due to the fact that the coercitivity Hc decreases and the stray field increases with increasing temperature. When this overlap becomes too large, correct readout of a space is no longer possible because false signals are generated by neighboring marks. The difference between this maximum and the minimum laser power determines the power margin, which decreases strongly with decreasing bit length. Experiments have shown that with the current readout methods, bit lengths of 0.10 μm can be correctly detected, but at an extremely narrow power margin (i.e. 1 bit of a 16 bit DAC (Digital Analog Converter)). Hence, balancing of the optical power and the intensity of the external magnetic field is an important factor for determining optimum conditions.

However, even if optimum conditions have been set during an initial stage of a reading operation, the initial balance may be disturbed during reading due to environmental changes. These environmental changes may comprise field blurring, disc tilt, temperature changes, thickness non-uniformities of the protective coat of the disc, influences of the slider movement on the magnetic head, etc. Thus, controlling the optical power and the magnetic field strength during readout is essential.

JP-A-2000-215537 discloses a method and apparatus for controlling the optical power and/or the field strength of the external magnetic field by reading from a specific section on the disc an item of information defining a prescribed section on the disc and a pulse information defining a prescribed pulse number. Then, the number of pulses contained in the information read from the prescribed section is counted and compared with the pulse information. The optical power or the field strength is then adjusted on the basis of the comparison result.

Furthermore, WO03/023767A2 discloses a system for controlling radiation power and/or field strength during a reading operation from a magneto-optical recording medium. A pulse pattern in the reading signal is analyzed, and the analysis result is compared with a runlength characteristic of the data stored in the storage layer of the recording medium. The radiation power and/or the magnetic field strength are controlled in dependence on the comparison result. Much less or no disc capacity has to be reserved for power and/or field calibration as a result of this, since the user data can be used for this purpose.

Robust detection of runlength violations means e.g. that the smallest allowed mark runlength is not detected. Similarly, detection of a runlength greater than the maximum allowed length indicates a runlength violation. However, to detect the violation, i.e. the number of additional or missing peaks, with a reasonable reliability, the observed (random) data sequence has to be sufficiently large. This means that a lot of data errors are made before a suitable control signal is obtained that can be used to correct the readout conditions. Moreover, the discrete nature of the error signal makes it far from straightforward to design a robust control loop.

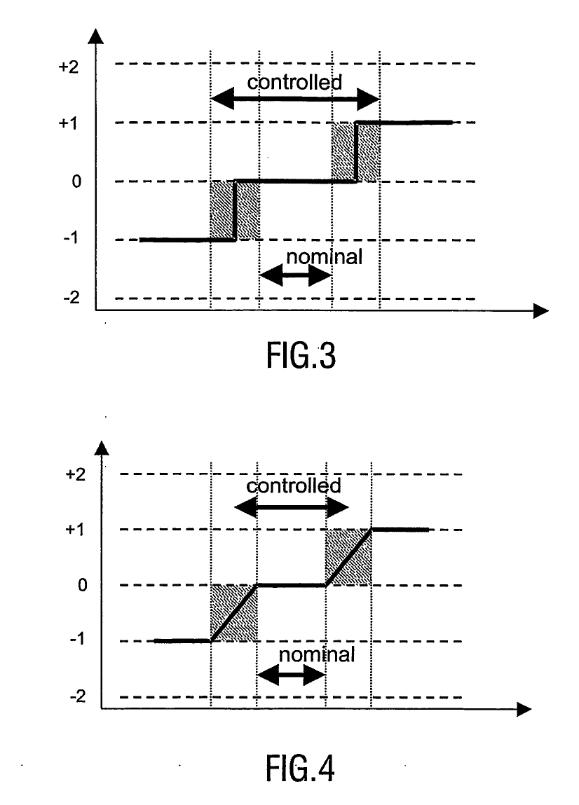

FIG. 3 is a diagram showing an error signal value vs. readout parameters, where the error signal is varied in a stepwise manner in dependence on the value of the readout parameter(s). As indicated in FIG. 3, this becomes even worse in case of a non-uniformity in the disc's optical or magnetic properties, for example. When a readout parameter is just outside the nominal range, a number of data errors is made while the error signal is still zero. For example, a +1 peak may occur which is, however, still below the decision threshold, so that no corrective action is taken. Only when the readout parameter deviates sufficiently, the number of errors is large enough to generate an error signal. Hence, the conventional discrete nature of the error signal has the drawback of coarse control and slow response with a considerable amount of readout errors.

It is an object of the present invention to provide a method, an apparatus and a runlength-limited coding scheme for providing an improved readout parameter control with increased robustness.

This object is achieved by a control method and apparatus as claimed in claim 1 and claim 8, respectively, by a recording method and apparatus as claimed in claim 5 and claim 11, respectively, and by a record carrier as claimed in claim 14.

Accordingly, the applied code constraint provides a guaranteed average runlength that is the same for any runlength sequence greater than a given number of runlengths.

This provides the advantage that a code with this property automatically provides a suitable signal for a much improved control of readout parameters such as control copy window and/or phase control loop. The error signal can be obtained by continuously monitoring the average detected runlength and subtracting the pre-determined average runlength, which is a code property that is to be decided at the encoder side. The obtained error signal is thus continuous and smooth, unlike the prior art control of FIG. 3, making the control loop easier to design and more robust. Thanks to the proposed code property, the onset of the first readout errors directly causes a deviation in the average detected runlength and thus gives a proportional error signal which can be used as an input for a control loop. Since all detected runlengths in the proposed code thus contribute to the error signal instead of only the minimum and maximum runlength, the response is much faster and a short data sequence is already sufficient for a reliable signal. Therefore, much fewer readout errors are made than in the prior art method, also because the readout parameters can be kept very close to the range of nominal readout parameters.

This strong reduction in readout or burst errors compared with the prior art has the additional advantage that the redundancy required for error correction coding (ECC) can be much reduced. Therefore, higher user densities can be achieved, even though the additional constraint somewhat reduces the code rate. The density gain derived from reduced ECC requirements is significantly greater than the small loss caused by the additional code constraint.

Compared with other possible techniques, the suggested solution has a further advantage that the control is applied directly to the user data and that no capacity or formatting time is lost on power calibration regions provided on the record carrier, e.g. magneto-optical disc.

The at least one readout parameter may comprise at least one of the following quantities: the radiation power and the strength of an external magnetic field applied during the reading operation.

Furthermore, storing means may be provided for storing an information defining a relationship between a value of said error signal and a value of the comparison result. The control behavior can thus be individually set in dependence on user preferences or other conditions, such as disc or environmental conditions.

The code constraint may be applied to the recording data in such a manner that only the accumulated deviation of runlengths of mark regions is kept within the predetermined range. Specifically in readout systems where reading signals are only generated from mark runlengths, such as for example MAMMOS systems, the same performance can be achieved at much better overall code rates.

The applying step may comprise a decision on the allowability of a new runlength based on the history of emission of preceding runlengths. Memory functionality is introduced into the emission of runlengths thereby. To achieve this, the code generating means may comprise a finite state machine, also known as state-transition diagram. Such a diagram is the basis on which code construction is carried out.

Other advantageous further developments are defined in the dependent claims.

In the following, the present invention will be described on the basis of a preferred embodiment with reference to the accompanying drawings in which:

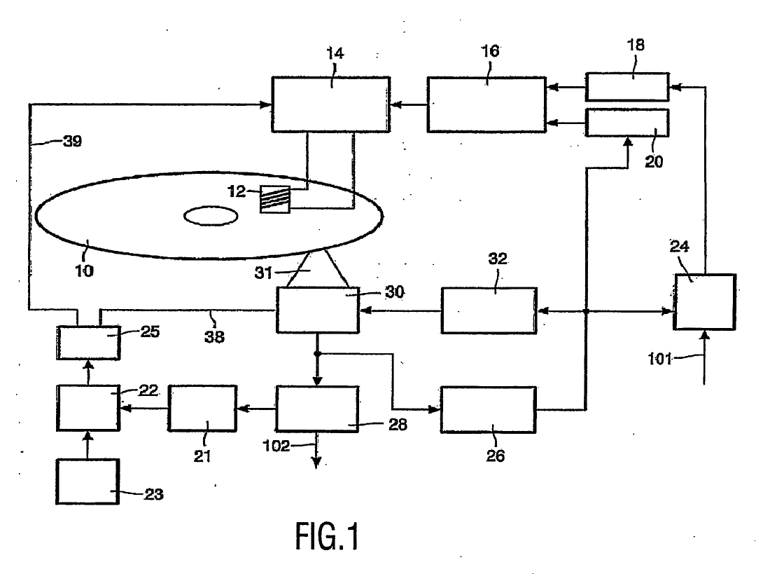

FIG. 1 is a diagram of a magneto-optical disc player according to the preferred embodiment;

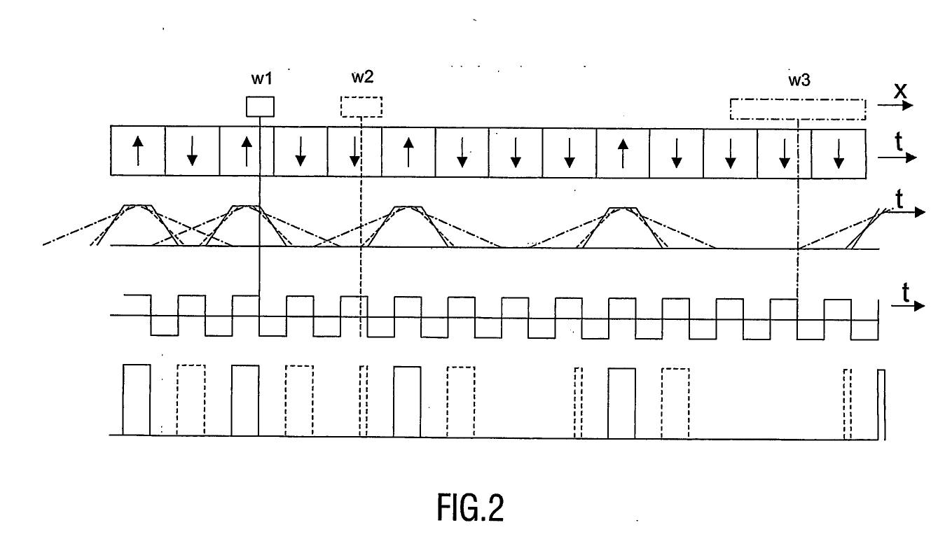

FIG. 2 shows signaling diagrams of a readout strategy with different degrees of overlap;

FIG. 3 is a diagram showing an error signal vs. readout parameters for a prior art readout control with a discrete nature of the error signal;

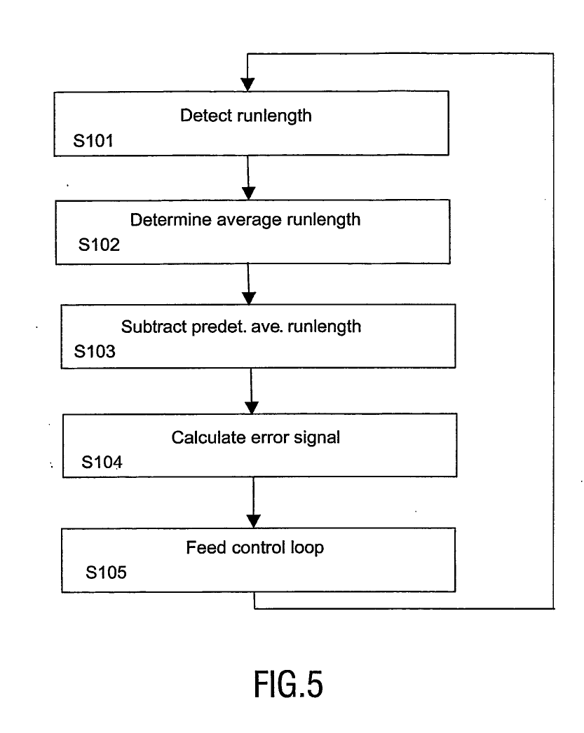

FIG. 4 is a diagram showing an error signal vs. readout parameters for an improved readout control with a continuous nature of the error signal according to the preferred embodiment;

FIG. 5 is a flow chart of a control procedure according to the preferred embodiment;

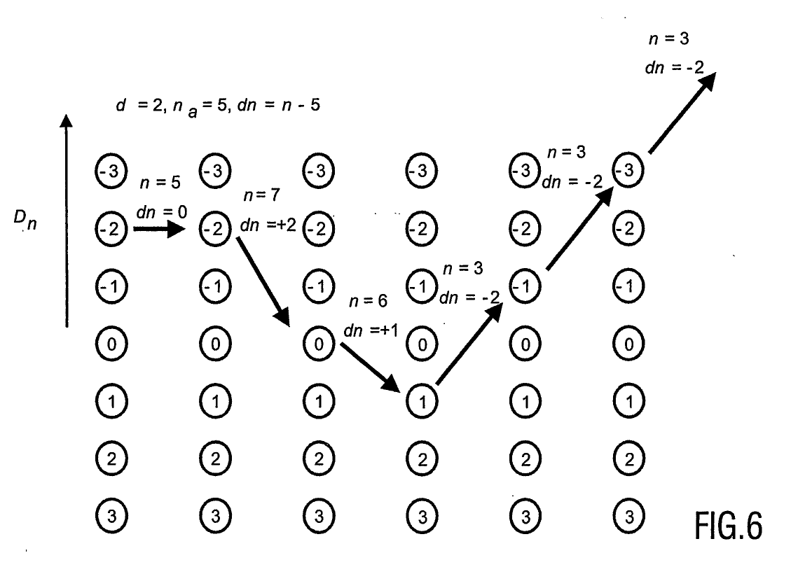

FIG. 6 shows a time-dependent graph of different possible accumulated runlength deviation states of a finite state machine for generating a runlength sequence;

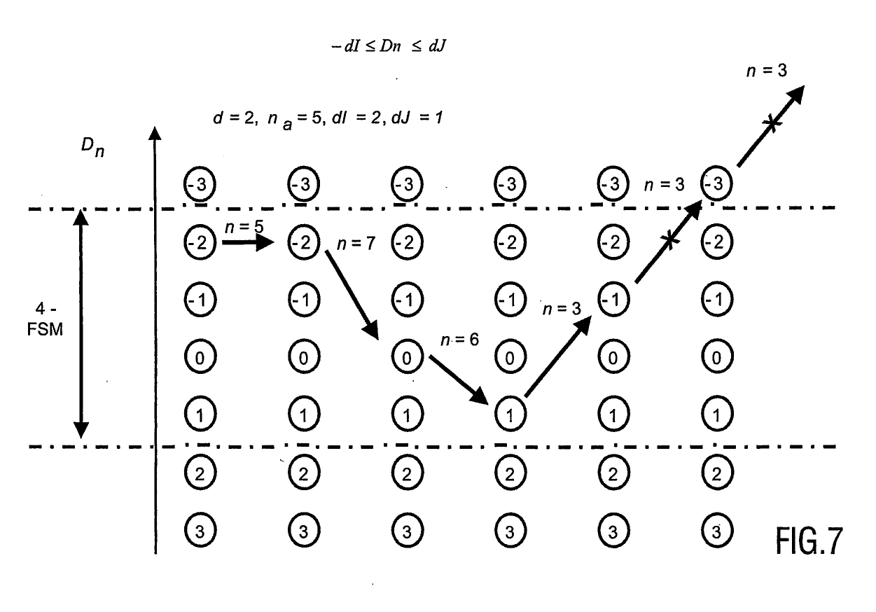

FIG. 7 shows a time-dependent graph similar to FIG. 6, where some accumulated runlength states are indicted as being forbidden because of an additional constraint according to the preferred embodiment;

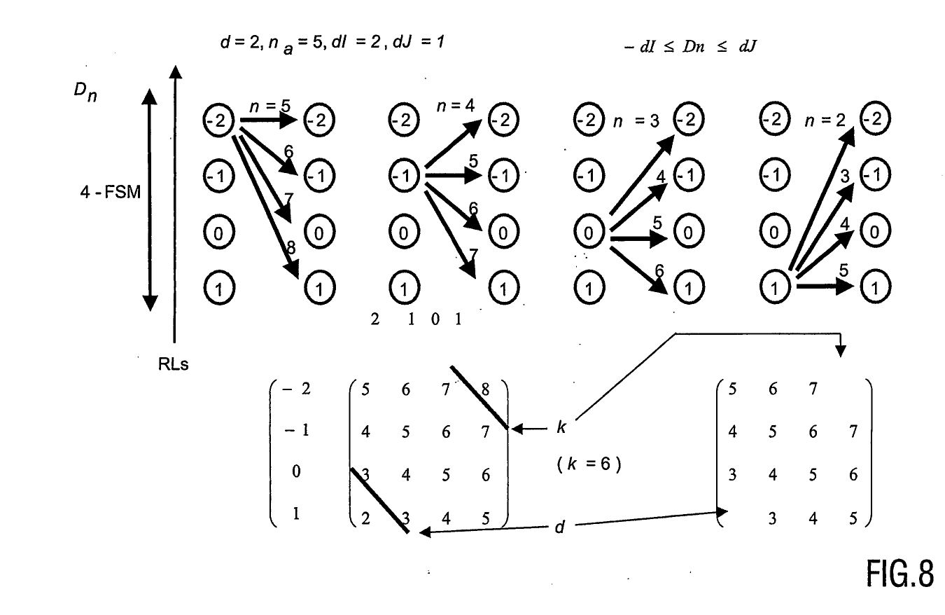

FIG. 8 shows a summarizing graph of runlengths forbidden on account of a code constraint according to the preferred embodiment;

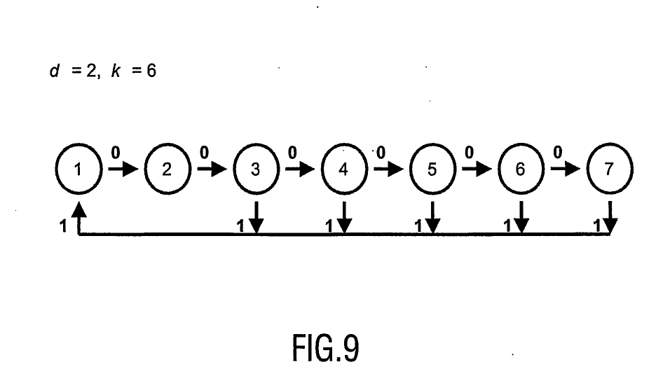

FIG. 9 shows a state transition diagram of a conventional runlength generator with minimum and maximum runlength constraints;

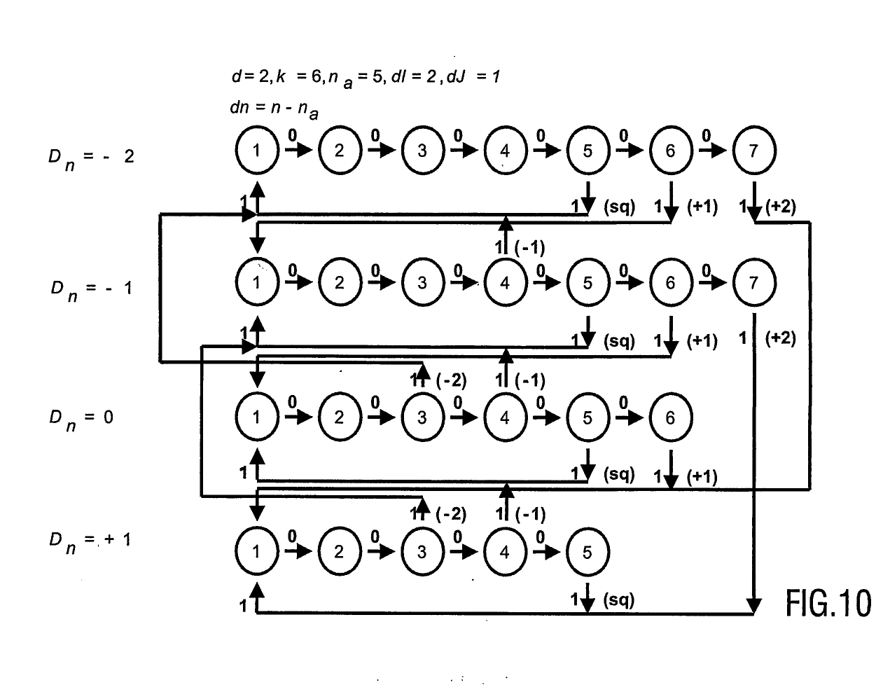

FIG. 10 shows a state transition diagram of an example of a runlength generator with an additional constraint for predetermined accumulated runlength deviations according to the preferred embodiment;

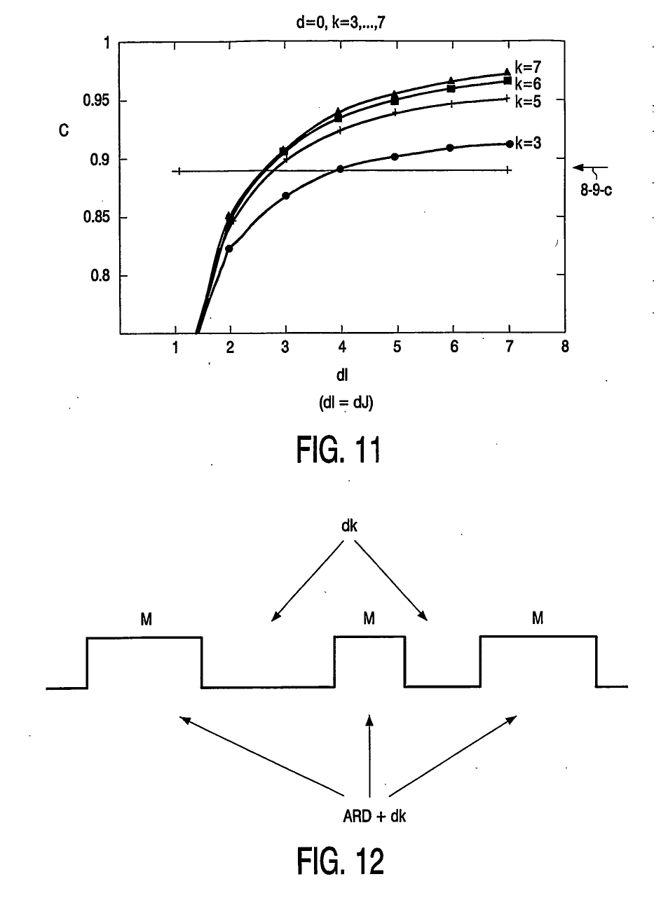

FIG. 11 is a diagram showing capacity vs. average runlength constraint for a code without minimum runlength constraint and with different maximum runlengths constraints combined with an additional constraint according to the preferred embodiment;

FIG. 12 diagrammatically shows a reading signal with different mark and space constraints according to the preferred embodiment;

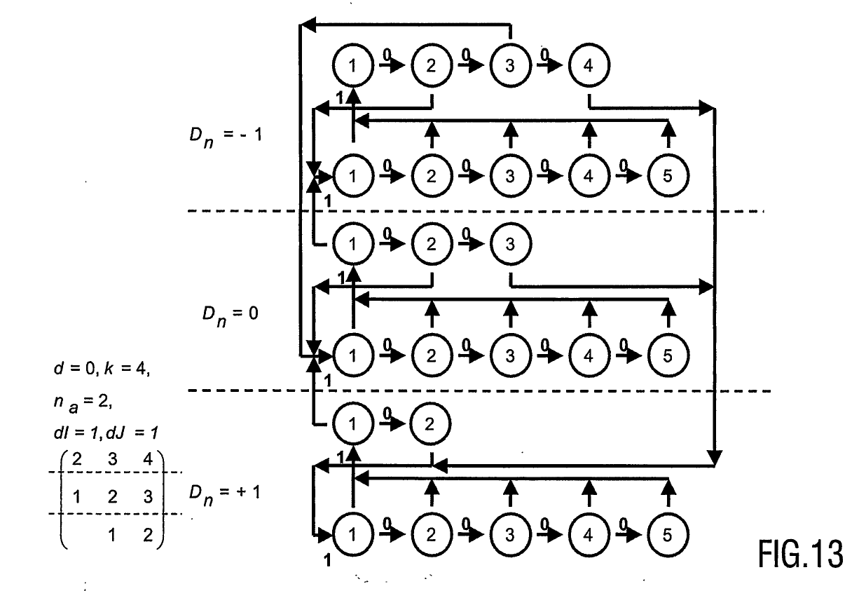

FIG. 13 shows an example of a state transition diagram for an additional mark-only constraint according to the preferred embodiment;

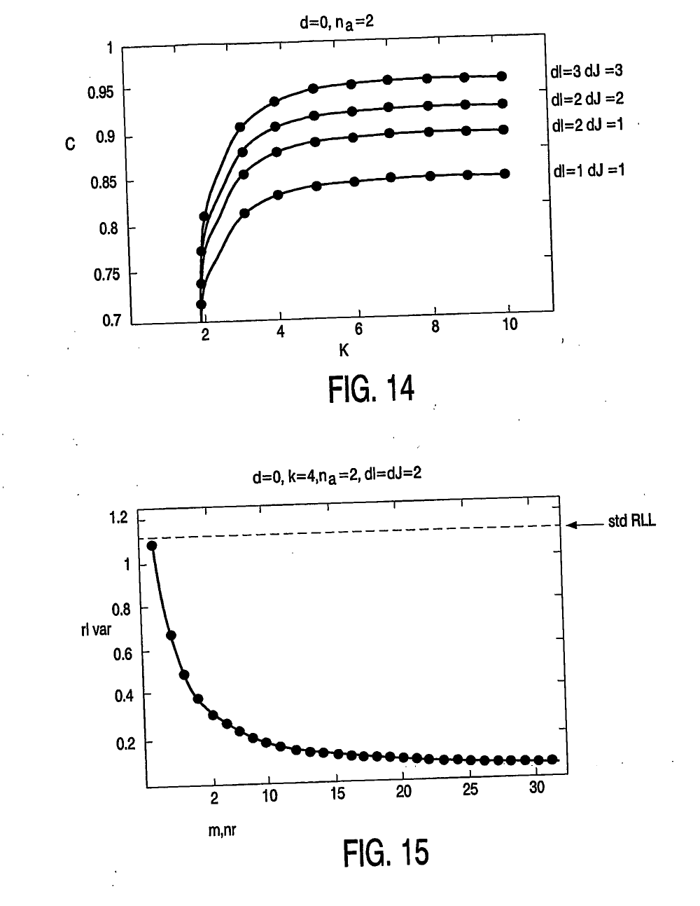

FIG. 14 is a diagram showing capacity vs. maximum runlength constraint for different additional runlength constraints according to the preferred embodiment for the case without a minimum runlength constraint; and

FIG. 15 is a diagram showing runlength variance vs. number of consecutive runlengths for a code with an additional constraint according to the preferred embodiment.

A preferred embodiment will now be described on the basis of a MAMMOS disc player as shown in FIG. 1.

FIG. 1 schematically shows the construction of the disc player according to the preferred embodiment. The disc player comprises an optical pick-up unit 30 having a laser light radiating section for irradiation of a magneto-optical recording medium or record carrier 10, such as a magneto-optical disc, with light that has been converted, during recording, into pulses with a period synchronized with code data and a magnetic field applying section comprising a magnetic head 12 which applies a magnetic field to the magneto-optical disc 10 in a controlled manner during recording and playback. In the optical pick-up unit 30, a laser is connected to a laser driving circuit which receives recording and readout pulses from a recording/readout pulse adjusting unit 32 so as to control the pulse amplitude and timing of the laser of the optical pick-up unit 30 during a recording and readout operation. The recording/readout pulse adjusting circuit 32 receives a clock signal from a clock generator 26 which may comprise a PLL (Phase Locked Loop) circuit.

It is noted that, for reasons of simplicity, the magnetic head 12 and the optical pickup unit 30 are shown on opposite sides of the disc 10 in FIG. 1. However, according to the preferred embodiment, they should be arranged on the same side of the disc 10.

The magnetic head 12 is connected to a head driver unit 14 and receives code-converted data via a phase adjusting circuit 18 from a modulator 24 during recording. The modulator 24 converts input recording data into a prescribed code.

During playback the head driver 14 receives a clock signal via a playback adjusting circuit 20 from the clock generator 26, which playback adjusting circuit 20 generates a synchronization signal for adjusting the timing and amplitude of pulses applied to the magnetic head 12. A recording/playback switch 16 is provided for switching or selecting the respective signal to be supplied to the head driver 14 during recording and during playback.

Furthermore, the optical pick-up unit 30 comprises a detector for detecting laser light reflected from the disc 10 and for generating a corresponding reading signal applied to a decoder 28 which is arranged to decode the reading signal so as to generate output data. Furthermore, the reading signal generated by the optical pick-up unit 30 is supplied to a clock generator 26 in which a clock signal obtained from embossed clock marks of the disc 10 is extracted and which supplies the clock signal for synchronization purposes to the recording pulse adjusting circuit 32, the playback adjusting circuit 20, and the modulator 24. In particular, a data channel clock may be generated in the PLL circuit of the clock generator 26.

In the case of data recording, the laser of the optical pick-up unit 30 is modulated with a fixed frequency corresponding to the period of the data channel clock, and the data recording area or spot of the rotating disc 10 is locally heated at equal distances. Additionally, the data channel clock output by the clock generator 26 controls the modulator 24 to generate a data signal with the standard clock period. The recording data are modulated and code-converted by the modulator 24 to obtain a binary runlength information corresponding to the information of the recording data.

The structure of the magneto-optical recording medium 10 may correspond to the structure described, for example, in JP-A-2000-260079.

The occurrence of false signals due to a large overlap (e.g. laser power too high) should normally be avoided. However, if the correct data in the storage layer is known, the occurrence and number of false peaks gives a direct information on the spatial width of the copy window, which is directly related to the thermal laser profile. This information can not only be used to correct the previous and/or following data on the disc, but also provides a direct way to correct readout parameters, such as the laser power and/or the field strength of the external magnetic field.

In the preferred embodiment shown in FIG. 1, the laser power and/or the strength of the external magnetic field are controlled as examples of possible readout parameters. However, other suitable readout parameters influencing the copy window size or phase may be equally well controlled. A control unit 25 is provided for supplying first and second control or error signals 38, 39 to the head driver 14 and/or to the optical pickup unit 30. The first control signal 38 is supplied to the optical pickup unit 30 and can be used for adjusting the driving current of a laser diode or another radiation source, so as to adjust the optical radiation or laser power used for heating the disc 10. The second error signal 39 is supplied to the head driver and can be used to adjust the field current of a coil arrangement provided at the magnetic head, so as to adjust the field strength or intensity of the external magnetic field. The two error signals 38, 39 may be provided as alternative or combined error signals. In the latter case, the second error signal 39 supplied to the head driver 14 may be used for fine adjustment of the balance between the optical power and the field strength, while the first error signal 39 supplied to the optical pickup unit 30 may be used for rough adjustment. This is because a change in the optical power influences both the stray field and the coercitivity profile, whereas a change in the external magnetic field only influences the total stray field.

The control unit 25 receives a comparison result of a comparing unit 22 which compares the result of an analysis of the readout data obtained from the decoder 28 with reference data stored in a non-volatile memory, e.g. look-up table 23. The analysis is performed by an analyzing unit 21 which receives the readout data from the decoder 28.

FIG. 2 shows signaling diagrams for an example of a disc with a range of space (downward magnetization (indicated by a corresponding arrow)) runlengths (I1, I2, I3, I4), separated by I1 marks (upward magnetization), as indicated in the upper line which shows a spatial arrangement of magnetized regions on a track of the disc 10. The expression “In” denotes a space runlength with a duration corresponding to n channel bits (minimum space or mark regions), while the expression “In” denotes a mark runlength with a duration corresponding to n channel bits. The resulting time dependency of the overlaps (second line from above) upon scanning with different copy window sizes w1, w2 and w3 are also indicated, as well as the MAMMOS signals or peaks (fourth line) generated with the external magnetic field (third line). For conventional, correct readout, the copy window should be smaller than half the channel bit length b (as applies for the copy window size w1 in FIG. 2). In this case, each mark channel will yield one MAMMOS peak and no peaks are generated for space channels. Thus, detection of m consecutive peaks indicates an Im mark runlength, whereas s missing peaks indicate an Is space runlength. This situation is indicated by the solid line in FIG. 2. For larger window sizes, e.g. w2, MAMMOS peaks will also be generated for space regions near a mark region because of the larger overlap (dashed line in FIG. 2). For example, an I1 mark will now yield three peaks instead of one. Obviously, I1 and I2 spaces can no longer be detected now. An I3 space will show one missing peak (instead of three). Even larger window sizes (2.5b<w<4.5b), e.g. w3, cause a difference of four peaks in space and mark runlength detection, while a I5 space is the smallest space runlength that can be detected (by one missing peak).

Since the copy window increases with increasing laser power (as well as ambient temperature and external magnetic field), it is possible to control power and/or field during readout e.g. by detection of runlength violations in the written data and/or by using a test area with pre-defined data patterns consisting of known mark and space runlengths. The first option is especially attractive since much less or no disc capacity has to be reserved for power calibration, as the user data is used for this purpose. In this way, the effects of environmental changes, e.g. changes in the ambient temperature, the external field strength (coil to disc distance), and even mild variations in the disc properties can be corrected on the fly.

According to the preferred embodiment, an improved copy window and/or phase control method that solves the problems described above is to apply an additional code constraint next to the usual d and k runlength constraints for the minimum and maximum allowed mark and space runlengths. This new constraint on the accumulated runlength deviation keeps the deviation from the pre-determined average runlength within a specified range by introducing a memory functionality in the emission of runlengths. Stated differently, this constraint provides a guaranteed predetermined average runlength, which is the same for any runlength sequence greater than a small given number of runlengths.

The advantage obtained is that a code with this property automatically provides a suitable signal for a much improved copy window and/or phase control loop. This error signal is obtained by continuously monitoring the average detected runlength and subtracting the predetermined average runlength, which can be selected or set as a specific code property as part of the code conversion functionality of the modulator 24.

FIG. 4 shows a diagram of the first and/or second error signals 38, 39 (vertical axis) vs. the readout parameters, e.g. radiation power and/or field strength (horizontal axis), for an improved readout control with a continuous nature of the error signal, according to the preferred embodiment of the present invention. In FIG. 4, respective arrows indicate a range of nominal readout parameters, for which the first and/or second error signals 38, 39 are zero, and a range of controlled readout parameters. The controlled range comprises continuous regions where the error signal is varied continuously in dependence on the readout parameters. The shaded areas, where the error signal is varied continuously, represent transition regions caused by disc non-uniformity. This characteristic makes the control loop easier to design and more robust. Owing to the proposed code property, the onset of the first readout errors directly causes a deviation in the average detected runlength and thus gives a proportional error signal to be used by the control unit 25 as an input for the respective control loop(s). Since all detected runlengths in the proposed code contribute to the error signal instead of only the minimum and maximum runlength, the response is much faster, and a short data sequence may already be sufficient for obtaining a reliable signal, as will be discussed later. Therefore, much fewer readout errors are made, also because the readout parameters can be kept very close to the range of nominal readout parameters.

In a preferred embodiment, the proposed accumulated runlength deviation constraint can only be applied to the mark runlengths, due to the fact that MAMMOS signals are generated only from the mark runlengths and thus provide all necessary readout information. Restricting the constraint to the marks only therefore gives the same performance but at a much better code rate, typically an approximately 5% to 8% lower code rate than in the prior art (where the additional runlength constraint is absent), depending on the required code constraint, as against 8% to 15% lower rates for a code constraint on both marks and spaces.

A further improvement or optional modification, therefore, is to combine the above improved control with small test areas, e.g. those mentioned above or additional ones, provided on the disc e.g. at regular intervals with a known data pattern, e.g. an I1I1 or an I3I3 carrier or an I1I3I3I1 pattern. The number of additional peaks is directly obtained from such a known pattern by counting the detected number of peaks and subtracting the expected number. Since a small number of runlengths are already sufficient for reliable detection in this case, many such areas can be provided while keeping the capacity overhead very small.

FIG. 5 is a flow chart of a control procedure according to the preferred embodiment. In step S101, at least one runlength is detected, for example by the analyzing unit 21. Then, in step S102, an average runlength is determined, e.g. by the analyzing unit 21. In step S103, the comparing unit 22 subtracts from the determined average runlength a code-specific predetermined average runlength, which may be stored in a memory means, such as a lookup Table 23. The control unit 25 calculates the first and/or second error signals 38, 39 from the subtraction result in step S104 and feeds these first and/or second error signals 38, 39 to the respective control loop(s) in step S105.

The calculation of the error signal(s) 38, 39 may be based on a predetermined relationship between the comparison result and the error signal(s), which relationship may also be stored in the lookup table 23. The predetermined relationship can then be set individually on the basis of at least one of the disc properties, control characteristics, environmental conditions, user preferences, and the like.

As an additional measure or improvement, runlength violation results determined by the comparing unit 22 from the optional test areas may be used to support or enhance the obtained error or control signals.

The proposed introduced additional code constraint according to the preferred embodiment will now be described in more detail with reference to specific examples of runlength limited (RLL) codes. The additional code constraint provides a limitation of accumulated runlength deviations and thus preserves the average runlength of the RLL codes. In view of this, the proposed RLL codes with the additional code constraint may be called “average runlength preserving RLL codes”.

In the following explanations, n is used to designate the runlength, and nₐ is used to designate the envisaged or desired average runlength and is selected as an integer value for limited Trellis complexity, to be chosen close to the average runlength for the conventional d/k constraints due to the fact that any deviation costs code rate. Furthermore, dn=n−nₐ is used to designate the runlength deviation and can assume a positive or negative value. Finally, Dₙ^{j}=Dₙ^{j-1}+dnⱼ is used to designate the accumulated runlength deviation (ARD) for the j-th runlength, integrated over runlengths. It is noted that the ARD constraint is clearly different from yet another constraint in runlength-limited coding, which is a constraint on the running digital sum (RDS) as is used for DC-control. As an example, a series of runlengths all being smaller than the targeted average runlength nₐ, can be fully DC-free with an RDS within clear limits, whereas the ARD constraint is clearly violated.

FIG. 6 is an explanatory time-dependent graph showing different possible accumulated runlength deviation states of a finite state machine (or state transition diagram) for generating a runlength sequence. Such a (finite) state machine (FSM) can be thought of as a black box that generates runlength sequences according to specific rules, such as the d and k constraint of minimum and maximum runlength, respectively. In particular, FIG. 6 shows a trellis, which is a graphical representation of the different possible states of such a state machine on the vertical axis and consecutive runlengths on the horizontal axis as a measure of “time”. Any path through the Trellis corresponds to a unique sequence of runlengths. The different states correspond to the accumulated runlength deviation Dn. In the presented example, the envisaged average runlength nₐ=5, so that a runlength deviation dn=0 is generated when a runlength n=5 occurs. The ARD thus remains constant (horizontal arrow) in the left first step of FIG. 6. The next runlength is n=7, i.e. two units above the envisaged value, so that the second step of the path has to move down two states in the trellis. With a next runlength n=6, the path has to move down one state, with n=3 the ARD is reduced and the path moves two states up, etc. As can be seen, there is no hard limit on the minimum or maximum state number, and these values will depend on the data sequences that are to be encoded by the runlength-limited encoder.

FIG. 7 shows a state diagram similar to FIG. 6, where additional constraints −dI and dJ are placed on the minimum and maximum ARD, respectively. In the example shown in FIG. 7, the minimum allowed ARD is limited to −dI=−2 and the maximum allowed ARD is limited to dJ=1. This additional ARD constraint can be expressed as follows:
−dI≦Dn≦dJ
This means that certain runlengths are not allowed, depending on the previous runlengths, if the resulting ARD exceeds the maximum allowed value dJ=1 or falls below the minimum allowed value −dI=−2. As can be gathered from FIG. 7, the last two runlengths n=3 are not allowed because of the additional constraints. The above limitation reduces the number of allowable ARDs to 4, so that the constrained code can be expressed as a 4-state FSM.

In a standard RLL code, certain sequences will not yield a predetermined average runlength. With the proposed additional constraint on ARD, the resulting ARD code yields the predetermined average runlength, but a “memory” is required in the emission of runlengths, which means that the allowed runlengths depend on the previous runlengths.

In mathematical terms, the average accumulated runlength deviation (A-ARD) for N runlengths can be calculated as follows:

$${〈 ( {n}_{j} - {n}_{a} ) 〉}_{N} = \frac{{\sum }_{j = 1}^{N} ( {n}_{j} - {n}_{a} )}{N} = \frac{{D}_{n}^{N} - {D}_{n}^{0}}{N} {⟶}^{N \to ∞} 0$$

Hence, large numbers of consecutive runlengths are required statistically in order to obtain the desired average runlength nₐ. The memory in the emission of runlengths, as introduced by the ARD code, serves to meet this requirement for a small number N of consecutive runlengths already.

FIG. 8 is a summarizing graph representing runlengths allowed in view of an ARD code constraint as indicated in FIG. 7. In particular, the 4×4 matrix lists the allowed runlengths that result in a transition from an ARD state i (vertical) to an ARD state j (horizontal). As indicated, the conventional d and k constraints forbid two of the indicated runlengths that would be allowed on the basis of the ARD-constraint only.

FIG. 9 shows a state transition diagram of a conventional runlength generator with minimum and maximum runlength constraints d=2 and k=6. Going through this state machine, all allowed runlengths can be generated, wherein here a “1” indicates a transition from one logical state to the other logical state of the binary signal. E.g., starting from state “1” (after a transition), we always get at least two 0's (non-transitions defining a minimum runlength according to the d constraint), and can return to state “1” via states “3” to “7” (the last possible return through state “7” corresponds to the k constraint, namely the maximum of 6 0's, or a runlength of 7T. A possible sequence would be:
(1)0010000001000001001 . . . ,
3T|7T⊕6T|3T| . . .
From such a state transition diagram it is straightforward to calculate the capacity of the code (smaller than 1; equal to 1 in the case of no coding, i.e. all runlengths allowed, or: d=0, k=Inf., no additional constraints). Furthermore, such a state-transition diagram is the basis for the construction of a practical code.

FIG. 10 shows a state transition diagram of an example of a runlength generator function provided in the modulator 24 with an additional predetermined ARD constraint according to FIG. 7. As can be gathered from this diagram, the additional ARD constraint leads to a significantly increased number of states and conditional branches due to the fact that the actually allowed range of runlengths depends on the previous ARD value Dₙ. The positive and negative values in brackets indicate the change in the ARD value and thus the change in the state transition queues, wherein “sq” (referring to a “status quo” in Dₙ) indicates a return to the first state of the same queue.

FIG. 11 is a diagram showing capacity C vs. ARD constraint dI for the case dI=dJ and for a code with different maximum runlength constraints k=3, 5, 6 and 7 when combined with the additional ARD constraint according to the preferred embodiment (no minimum runlength constraint is applied in this example). For dl greater than 2 and k greater than 3, the achieved capacity C is greater than for a standard RLL 8-to-9 code (indicated by the horizontal threshold line).

FIG. 12 is a schematic binary representation of a signal with different mark and space constraints according to the preferred embodiment. In particular, mark regions M are subject to the conventional d/k constraints and the proposed additional ARD constraint, while space regions are only subject to the conventional d/k constraints. As already mentioned, it is not necessary for MAMMOS systems to put any constraint on the spaces, as these do not give any peaks in the MAMMOS signal. Hence, restricting the ARD constraint to mark regions M only will lead to a higher code capacity.

FIG. 13 shows an example of a state transition diagram for a (d=0, k=4)−RLL code with an additional mark-only ARD constraint according to the preferred embodiment. Here, ARD constraints dI=dJ=1 have been set which lead to only three possible ARD states Dₙ and thus to a 3×3 matrix of allowed runlengths. Such a state transition diagram can be used in a known manner as a basis for a calculation of capacity and code construction. It is noted that the state-transition diagram is divided into three parts according to the Dₙ value: the bottom branch in each partition applies to the spaces, the top branch to the marks. Since the ARD constraint does not apply to the spaces this time, all bottom branches are identical and satisfy the d,k constraints.

FIG. 14 is a diagram showing capacity C vs. maximum runlength constraint k for various different additional ARD constraints dI, dJ according to the preferred embodiment. This relates to a practical example for a MAMMOS system where the conventional minimum runlength constraint is set to d=0. The additional ARD constraint is applied to mark regions only. For dI=dJ=2, the loss in code capacity C caused by the ARD constraint is about 8% (1.0-0.92).

FIG. 15 is a diagram showing runlength variance vs. number of consecutive runlengths for a code with an additional ARD constraint according to the preferred embodiment. The variance can be calculated from the following equations:
varₘ=\sqrt{ [symbol](n−nₐ)² [symbol] ₘ}, [symbol] nₘ=nₐ
As can be gathered from the diagram of FIG. 15, the runlength variance is very small after about 20 runlengths, i.e. the average runlength is guaranteed to be very close to the envisaged average runlength. This is not the case in standard RLL, as is illustrated by the dashed horizontal line.

More runlengths are needed to achieve such a low variance with larger ARD constraints dI, dJ, i.e. a more relaxed ARD constaint, but the code capacity C is higher then. A low variance is reached sooner for smaller dI, dJ, but at the cost of some additional capacity C, as can be gathered from FIG. 14.

It is noted that the present invention may be applied to any reading system for domain expansion magneto-optical disc storage systems. The functions of the analyzing unit 21, the comparing unit 22, the look-up Table 23, and the control unit 25 may be provided in a single unit which may be a hardware unit or a processor unit controlled by a corresponding control program. The readout data may be supplied directly from the optical pickup-unit 30 to the analyzing unit 21. The preferred embodiments may thus vary within the scope of the attached claims.

1. A method of controlling at least one readout parameter during a reading operation from a magneto-optical recording medium (10) comprising a storage layer and a readout layer, wherein an expanded domain leading to a pulse in a reading signal is generated in said readout layer by copying of a mark region from said storage layer to said readout layer upon heating by radiation power, said method comprising the steps of:
a) monitoring an average detected runlength of a read pulse pattern;
b) generating an error signal based on a comparison of the result of said monitoring step with said predetermined average runlength; and
c) controlling said at least one readout parameter on the basis of said error signal.

2. A method according to claim 1, wherein said at least one readout parameter comprises at least one of the following quantities: said radiation power and the strength of an external magnetic field applied during said reading operation.

3. A method according to claim, wherein said pulse pattern corresponds to the user data recorded on said recording medium (10).

4. A method according to claim 1, wherein said comparison is performed on the basis of a look-up Table linking the value of said error signal to a corresponding value of said comparison result.

5. A method of recording data on a magneto-optical recording medium (10) comprising a storage layer and a readout layer, said method comprising the step of applying a code constraint to said recording data, said code constraint being selected so as to keep the accumulated deviation from a predetermined average runlength of at least one of the following quantities: mark runlengths and space runlengths in said storage layer within a predetermined range.

6. A method according to claim 5, wherein said code constraint is applied to said recording data such that only the accumulated deviation of runlengths of mark regions is kept within said predetermined range.

7. A method according to claim 5, wherein said applying step comprises a decision on the allowability of a new runlength in dependence on the history of emission of preceding runlengths, said history being characterized by a resulting state in a state-transition diagram for the code constraint that corresponds to the value of the accumulated deviation value realized thus far.

8. An apparatus for controlling at least one readout parameter during a reading operation from a magneto-optical recording medium (10) comprising a storage layer and a readout layer, wherein an expanded domain leading to a pulse in a reading signal is generated in said readout layer by copying of a mark region from said storage layer to said readout layer upon heating by radiation power, said apparatus comprising:
a) monitoring means (21) for monitoring an average detected runlength;
b) generating means (22) for generating an error signal based on a comparison of the result of said monitoring step with said predetermined average runlength; and
c) control means (25) for controlling said at least one readout parameter on the basis of said error signal.

9. An apparatus according to claim 8, wherein said at least one readout parameter comprises at least one of the following quantities: said radiation power and the strength of an external magnetic field applied during said reading operation.

10. An apparatus according to claim, further comprising storing means (23) for storing information that defines a relationship between a value of said error signal and a value of the result of said comparison.

11. An apparatus for recording data on a magneto-optical recording medium (10) comprising a storage layer and a readout layer, said apparatus comprising code generating means (24) for applying a code constraint to said recording data, said code constraint being selected so as to keep the accumulated deviation from a predetermined average runlength of at least one of the following quantities: mark runlengths and space runlengths in said storage layer within a predetermined range.

12. An apparatus according to claim 11, wherein said code generating means (24) comprises a finite state machine.

13. An apparatus according to claim 8, wherein said apparatus is a disc player for MAMMOS discs.

14. A magneto-optical record carrier comprising a storage layer and a readout layer, wherein an expanded domain leading to a pulse in a reading signal is generated in said readout layer by copying of a mark region from said storage layer to said readout layer upon radiation heating with the help of an external magnetic field, and wherein a runlength constraint is applied to at least one of the following quantities: mark regions and space regions in said storage layer, said runlength constraint being selected to keep an accumulated runlength deviation from a predetermined average runlength within a predetermined range.

15. A record carrier according to claim 14, wherein said record carrier is a MAMMOS disc (10).
